(19) United States
(12) Patent Application Publication
(10) Pub. No.: US 2022/0171132 A1
(43) Pub. Date: Jun. 2, 2022

(54) WAVELENGTH DIVISION MULTIPLEXING DEVICES WITH STAGGERED FILTERS AND METHODS OF MAKING THE SAME

(71) Applicant: CORNING RESEARCH & DEVELOPMENT CORPORATION, Corning, NY (US)

(72) Inventors: Andreas Matiss, Berlin (DE); Martin Spreemann, Berlin (DE)

(21) Appl. No.: 17/521,145

(22) Filed: Nov. 8, 2021

Related U.S. Application Data
(60) Provisional application No. 63/119,067, filed on Nov. 30, 2020.

(51) Int. Cl. G02B 6/293; H04J 14/02

(52) U.S. Cl. CPC G02B 6/29368; H04J 14/0267; G02B 6/2938

(57) ABSTRACT

A wavelength division multiplexing (WDM) device comprises: a substrate; a common port coupled to the substrate and configured for communication of a combined optical signal that includes different signal channels; and filters coupled to the substrate. The common port and the filters define an optical path for the combined optical signal. Each filter is configured to pass one of the signal channels and to reflect any remainder of the signal channels. The filters have a staggered arrangement to facilitate automated assembly. Methods of such automated assembly are also disclosed.

### PRIORITY APPLICATION

This application claims the benefit of priority of U.S. Provisional Application No. 63/119,067, filed on Nov. 30, 2020, the content of which is relied upon and incorporated herein by reference in its entirety.

### BACKGROUND

The disclosure relates generally to wavelength division multiplexing and demultiplexing, and more particularly to wavelength division multiplexing devices having filters arranged in a staggered manner to facilitate automated manufacturing.

Wavelength division multiplexing (WDM) is a technology that: (a) combines a number signal components (“channels”), each associated with a different wavelength of light, for simultaneous transmission over an optical fiber; and (b) divides the combined signal following the transmission. Devices that combine the signal components are referred to as “multiplexers” and are associated with a transmitter. Devices that divide the combined signal are referred to as “demultiplexers” and are associated with a receiver. As can be appreciated, these devices may be used as components in an optical network, such as a passive optical network (PON), to increase the information capacity of optical fibers in the network.

FIG. 1 is a diagram illustrating an example of a WDM device 100. The WDM device 100 includes a common port 102, a plurality of channel ports 104(1)-104(8) (each may be referred to generally as a channel port 104 and collectively as channel ports 104), and a plurality of filters 106(1)-106(8) (each may be referred to generally as a filter 106 and collectively as filters 106). The common port 102 is configured for optical communication of a combined signal including a plurality of signal components/channels. Each of the channel ports 104 is configured for optical communication of one of the signal components. In particular, the common port 102 is configured to direct the combined signal along an optical path 108 that includes the filters 106. Each of the filters 106 is configured to pass a different one of the signal components to the associated channel port 104 while reflecting any remaining signal components to the next filter 106 (until the last filter 106(8)). The channel ports 104 are divided into a first channel set 110(1) and a second channel set 110(2). The filters 106 are divided into a first filter set 112(1) aligned along a first axis A₁ and a second filter set 112(2) aligned along a second axis B₁ that is spaced from the first axis A₁ by a distance X₁.

To properly filter and route the signal components, each filter 106 requires that the optical signal path 108 intersects the filter 106 within a maximum angle of incidence (AOI) of the filter 106. The AOI is the angle that the signal in the optical path 108 makes with a line perpendicular to the surface of the filter 106 upon which the signal is incident. For example, the common port 102 and filters 106 are configured so that the optical path 108 intersects the first filter 106(1) at a first AOI α1(1), intersects the second filter 106(2) at a second AOI α1(2), etc.

Filters may have different maximum AOls depending on the application in which the filters are used. For example, in dense wavelength division multiplexing (DWDM) applications, the signal channels are relatively close to each other in wavelength. In other words, there is not much separation between the different wavelengths associated with the different signal components/channels. The filters 106 for DWDM applications have relatively narrow passbands and small maximum AOIs compared to filters for other WDM applications (e.g., course wavelength division multiplexing, or “CDWM”). This presents challenges in keeping the footprint of the WDM device relatively small. For example, filters 106 that have smaller maximum AOls require larger distances X1 between the first filter set 112(1) (and the common port 102) and the second filter set 112(2) to accommodate the smaller maximum AOls. To prevent a further increase in the overall footprint, the filters 106 in each filter set 112 are positioned close to adjacent filter(s) 106 in the same filter set 112. FIG. 1 illustrates a relative distance Yi between adjacent filters 106 in the second filter set 112(2). This distance is often minimized in DWDM applications to the extent possible.

For example, FIG. 2 illustrates a DWDM device 200 having the type of arrangement just described. FIG. 2 generally corresponds to one implementation of the diagram in FIG. 1, and similar reference numbers are used in FIG. 2 to refer to elements corresponding to those discussed with reference to FIG. 1. The common port 102 and the channel ports 104 are shown in the form collimators from which optical fibers 202 extend, with the collimators and the filters 106 mounted to a substrate 204. The filters 106 are thin-film filters (TFFs) having a generally rectangular prismatic configuration. As can be seen FIG. 2, the filters 106 within each of the filter sets 112 are arranged in a linear array, side-by-side along either along the first axis A1 or the second axis A2. Although such an arrangement may help reduce the overall footprint of the DWDM device 200, assembling the DWDM device 200 can be challenging. The filters 106 are typically positioned manually by an operator using precision tweezers, needles, or other handheld elements. Fiducial marks (not shown) may be provided on the substrate 204 to assist with such positioning, which may be performed under a visual scope or other means to enhance the operator's view. Regardless, the assembly process remains dependent on operator skill and is labor-intensive, which can also make the process costly.

### SUMMARY

Embodiments of wavelength division multiplexing (WDM) devices are provided in this disclosure. The WDM devices have a particular arrangement of filters that facilitates automated assembly of the filters onto a substrate. Space to either side of each filter is not occupied by a neighboring filter (i.e., a different filter of the WDM device that is closest to the side in question), thereby allowing each filter to be held between robotic gripping arms during assembly onto the substrate.

According to one embodiment, a WDM device comprises: a substrate; a common port coupled to the substrate and configured for communication of a combined optical signal that includes different signal channels; and a plurality of filters coupled to the substrate. The common port and the plurality of filters define an optical path for the combined optical signal, with each filter of the plurality of filters being configured to pass one of the signal channels and to reflect any remainder of the signal channels. Each filter of the plurality of filters comprises an optical surface in the optical path, a back surface opposite the optical surface, and opposed sides extending between the optical surface and the back surface. The plurality of filters have a staggered arrangement so that the opposed sides of each filter face a respective region over the substrate that is not occupied by a neighboring filter in the plurality of filters.

Corresponding methods are also disclosed. For example, according to one embodiment, a method of assembling a wavelength division multiplexing (WDM) device comprises: arranging a common port on a substrate, wherein the common port is configured for communication of a combined optical signal that includes different signal channels; and arranging a plurality of filters on the substrate, wherein the common port and the plurality of filters define an optical path for the combined optical signal, with each filter of the plurality of filters being configured to pass one of the signal channels and to reflect any remainder of the signal channels. Each filter of the plurality of filters comprises an optical surface in the optical path, a back surface opposite the optical surface, and opposed sides extending between the optical surface and the back surface. The plurality of filters are arranged on the substrate to have a staggered arrangement so that the opposed sides of each filter face an associated region over the substrate that is not occupied by a neighboring filter in the plurality of filters.

In some embodiments, arranging the plurality of filters on the substrate further comprises moving each filter of the plurality of filters into a desired position on the substrate with robotic gripping arms. The robotic gripping arms hold the opposed sides of the filter during such moving. Additionally, in some embodiments, for each filter of the plurality of filters, the robotic gripping arms hold the filter in its desired position until the filter is secured relative to the substrate.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic diagram of an example WDM device having eight filters arranged in a conventional manner.

FIG. 2 is a schematic perspective view of a WDM device that is one potential implementation of the diagram illustrated in FIG. 1.

FIG. 3 is a schematic perspective view of one example WDM device according to this disclosure, with the WDM device including a plurality filters arranged on a substrate.

FIG. 4 is a schematic diagram of three of the filters in the WDM device of FIG. 3, with annotations added to one of the filters to denote regions adjacent to sides of the filter.

FIG. 5A is a schematic top view and FIG. 5B is a schematic front view of one of the filters of the WDM device of FIG. 3 being held between robotic gripping arms and positioned on the substrate by the robotic gripping arms.

FIG. 6 is a schematic perspective view of another example WDM device according to this disclosure, with the WDM device including a plurality filters arranged on a substrate.

FIG. 7 is a schematic diagram of three of the filters in the WDM device of FIG. 6, with annotations added to one of the filters to denote regions adjacent to sides of the filter.

FIG. 8 is a perspective view of an example steel tube collimator that may be used in WDM devices according to this disclosure, including the WDM devices of FIGS. 3 and 6.

FIG. 9A is a perspective view of an example square tube collimator that may be used in WDM devices according to this disclosure.

FIG. 9B is a cross-sectional top view of the square tube collimator of FIG. 9A.

FIG. 10A is a perspective view of an example compact collimator that may be used in WDM devices according to this disclosure.

FIG. 10B is a side view of the compact collimator of FIG. 10A.

FIG. 11A is a perspective view of an example array of the compact collimators of FIGS. 10A and 10B.

FIG. 11B is a close-up front view of the array of compact collimators of FIG. 11A.

FIG. 12 is a perspective view of an example WDM device with filters arranged on opposite sides of a substrate.

### DETAILED DESCRIPTION

Various embodiments will be clarified by examples in the description below. In this disclosure, terms such as “top,” “bottom,” “left,” “right,” “front,” “back,” etc. are used for convenience of describing the attached figures and are not intended to limit this description. For example, terms such as “top side” and “bottom side” are used with specific reference to the drawings as illustrated and the embodiments may be in other orientations in use. Further, as used in this disclosure, terms such as “parallel,” “perpendicular,” etc. include slight variations that may be present in working embodiments.

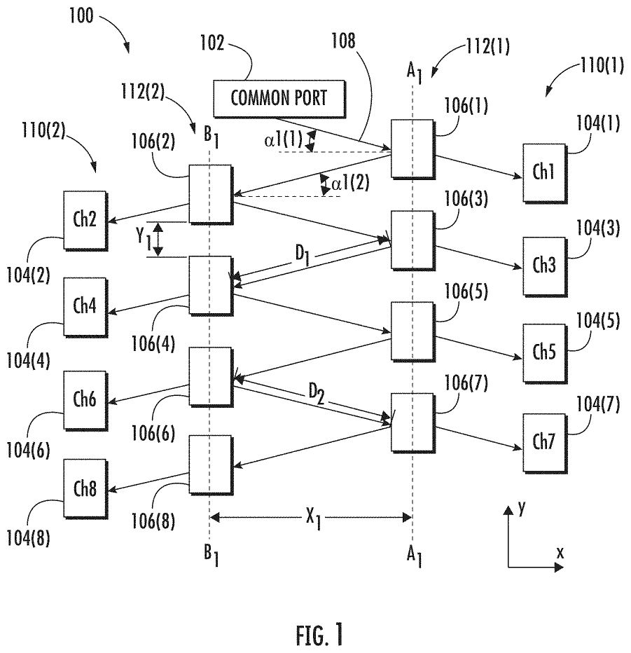

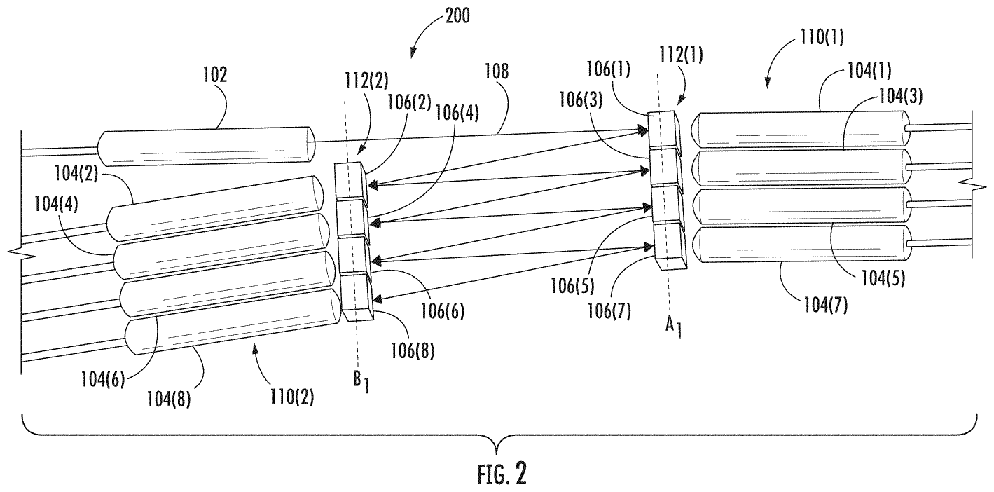

In general, the description relates to wavelength division multiplexing (WDM) devices based on the same principles described for the WDM devices 100, 200 (FIGS. 1 and 2) in the background section above. However, WDM devices according to this disclosure have a different arrangement of filters that facilitates automated assembly. The arrangement may be particularly beneficial for dense wavelength division multiplexing (DWDM) applications, but this disclosure is not limited to such applications. Embodiments according to this disclosure may be configured for other WDM applications, including coarse wavelength division (CWDM) applications.

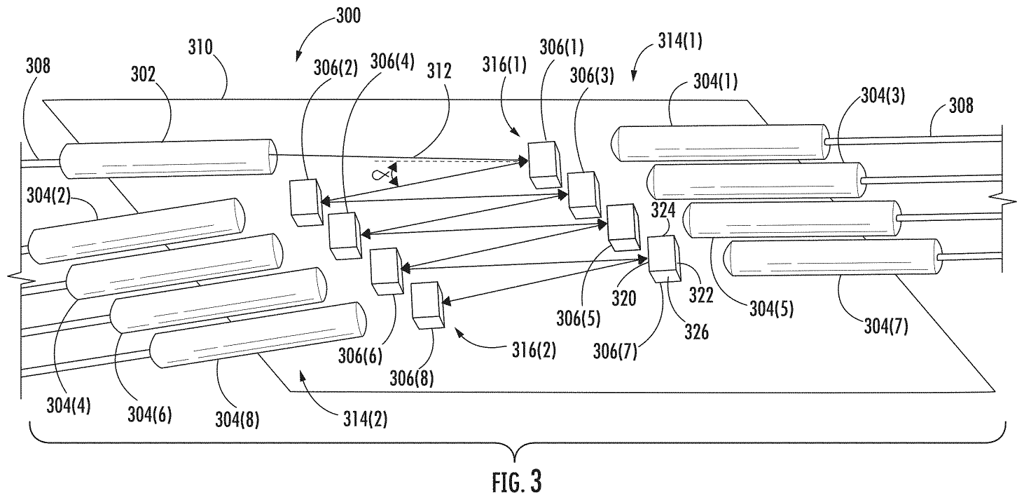

One example embodiment of a WDM device 300 according to this disclosure is shown in FIG. 3. The WDM device 300 includes a common port 302, a plurality of channel ports 304(1)-304(8) (each may be referred to generally as a channel port 304 and collectively as channel ports 304), and a plurality of filters 306(1)-306(8) (each may be referred to generally as a filter 306 and collectively as filters 306). The term “port” (e.g., as part of “common port” and “channel port”) refers to an interface for actively or passively passing (e.g., receiving and/or transmitting) optical signals. The common port 302 and channel ports 304 in FIG. 3 are schematically illustrated as cylindrical tube collimators from which optical fibers 308 extend. In alternative embodiments not shown, the common port 302 and/or the channel ports 304 may have a different form including one or more lenses, ferrules, optical fibers, optical connectors, or other optical elements. Various examples of other collimators that may be used as ports are described at the end of this detailed description. Although eight channel ports 304 and eight filters 306 are shown (for a combined optical signal with eight signal channels), alternative embodiments may involve a different number of channel ports and filters depending on how many signal channels are multiplexed or demultiplexed by the WDM device. The common port 302, the channel ports 304, and the filters 306 are coupled to a substrate 310, i.e. secured directly or indirectly relative to the substrate 310 by adhesive or other means. The substrate 310 may be a single component or multiple components assembled together to form a common base that supports the common port 302, the channel ports 304, and the filters 306.

Similar to the common port 102 (FIGS. 1 and 2), the common port 302 is configured for optical communication of a combined signal including a plurality of signal channels (also referred to as “signal components”). The signal channels are optical signals transmitted at different wavelengths or wavelength ranges. Each signal channel is associated with a different wavelength or wavelength range, with sufficient separation between the signal channels to allow selective filtering. In particular, each of the filters 306 is configured to pass one of the signal channels to one of the channel ports 304 and to reflect any remaining signal channels in the optical signal. In essence, each filter 306 isolates/divides the associated signal channel from the combined optical signal. The common port 302 and the filters 306 define an optical path 312 for the combined optical signal to travel from the common port 302 to the first filter 306(1), and then successively to the other filters 306(2)-306(8). The optical path 312 intersects each of the filters 306 at a certain angle of incidence (AOI) α. In the embodiment shown, each AOI α is nominally the same (i.e., the same but for acceptable manufacturing tolerances), but embodiments are also possible involving at least one different AOI in the optical path 312.

Also similar to FIGS. 1 and 2, the channel ports 304 are divided into a first channel set 314(1) and a second channel set 314(2), and the filters 306 are divided into a first filter set 316(1) and a second filter set 316(2). But unlike the WDM devices 100, 200 of FIGS. 1 and 2, the filters 306 of each filter set 316(1), 316(2) have a staggered arrangement instead of being aligned along an axis parallel to optical surfaces 320 of the filters 306. In particular, each filter 306 includes an optical surface 320 in the optical path 312, a back surface 322 opposite the optical surface 320, and opposed sides 324, 326 extending between the optical surface 320 and the back surface 322 (only the eighth filter 306(8) has its surfaces labelled in FIG. 3 to simplify the drawing). In the embodiment shown, the optical surface 320 faces the opposite filter set 316, and the back surface faces the associated channel port 304. In alternative embodiments the arrangement may be the opposite, with the optical surface 320 facing the associated channel port 304 and the back surface 320 facing the opposite filter set 316. Embodiments are also possible that alternate the arrangement, with some filters 306 having their optical surface 320 face the opposite filter set 316, and other filters 306 having their optical surface 320 face the associated channel port 304. Regardless of which direction the optical surface 320 faces, the staggered arrangement of the filters 306 is such that the opposed sides 324, 326 of each filter 306 are next to respective regions over the substrate 310 not occupied by a neighboring filter 306 (i.e., a filter closest to the side in question). The opposed sides 324, 326 of each filter 306 look toward (i.e., face/confront) the associated region, but not a neighboring filter 306 since the neighboring filter 306 (if there is one) is not positioned in the associated region.

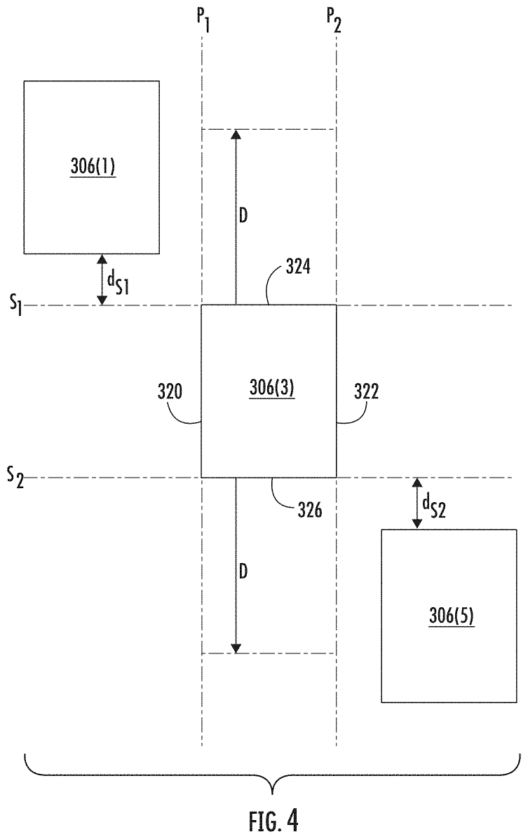

FIG. 4 is a schematic diagram of the filters 306(1), 306(3), and 306(5) from the WDM device 300 to assist with further describing the staggered arrangement of the filters 306. Geometric annotations are added to one of the filters 306 (filter 306(3)), which will be referred to as a “representative filter 306”, “given filter 306”, or “filter 306 in question”. The principles discussed with respect to that filter 306(3) may apply to any of the other filters 306 in the WDM device 300 (including those not illustrated in FIG. 4).

As shown in FIG. 4, the region over the substrate 310 that is faced by one of the sides 324, 326 of a given filter 306 is bound by first and second planes P₁, P₂ that are perpendicular to the side 324, 326 in question and extending from edges of the side 324, 326 in question. The first plane P₁ may include the optical surface 320 of the given filter 306, and the second plane P₂ may include the back surface 322 of the given filter 306. Neither the first plane P₁ nor the second plane P₂ intersect a neighboring filter 306 (filter 306(1) or filter 306(5) for the representative filter 306(3)) due to the staggered arrangement of the filters 306. Thus, any neighboring filter(s) 306 does not (or do not) occupy the region associated with the side 324, 326 in question. The associated region extends infinitely in the direction away from the side 324, 326 in question, or at least extends all the way to an edge of the substrate 310 (FIG. 3).

FIG. 4 also illustrates a distance D away from a given side 324, 236, with the distance D being measured perpendicular to the side 324, 326 and within the associated region. In some embodiments, the associated region remains unoccupied by any other filter 306, keeping in mind that the associated region extends all the way to an edge of the substrate 310 (FIG. 3). In other embodiments, the associated region remains unoccupied by any other filter 306 for at least the distance D, which in the illustrated embodiment is equal to a width of the filter 306 in question (the width being the distance between the opposed sides 324, 326). Such an arrangement provides sufficient open space for assembly equipment to grip the opposed sides 324, 326 of the filter 306. In other embodiments, the distance D is twice the width of the filter 306 in question.

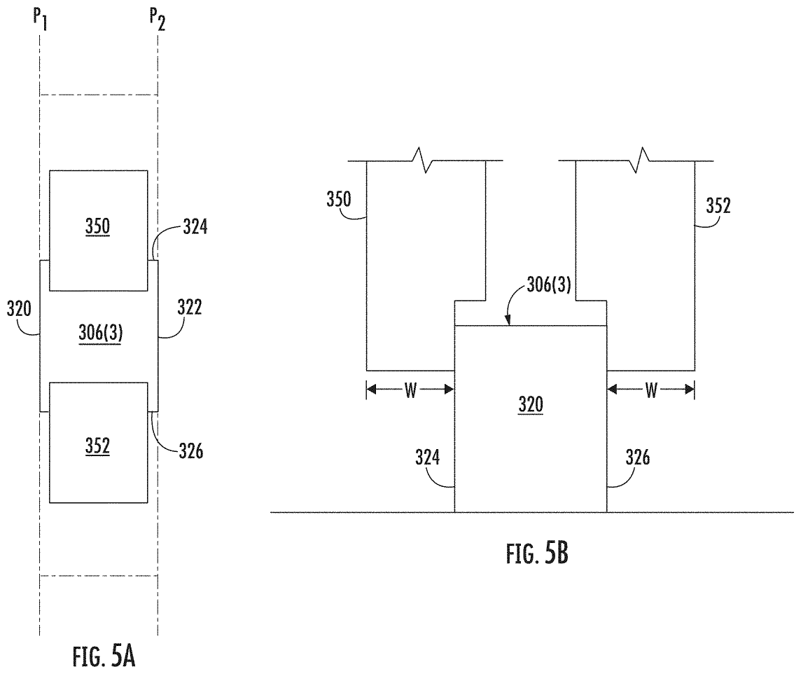

For example, FIGS. 5A and 5B illustrate the representative filter 306 of FIG. 4 being held between robotic gripping arms 350, 352. The portions of the gripping arms 350, 352 adjacent the opposed sides 324, 326 of the filter 306 each have a maximum width W, as measured in a plane perpendicular to the side in question, that is less than the distance D associated with the region faced by the side. Again, no other filter 306 occupies the region over the substrate 310 that is faced by the side in question (side 324 or 326) for at least the distance D due to the staggered arrangement of the filters 306. As a result, the gripping arms 350, 352 may be used to position each of the filters 306 on the substrate 310. The assembly process may be automated, with the gripping arms 350, 352 controlled by a machine (hence the label “robotic gripping arms 350, 352”), which may reduce overall time and operator sensitivity compared to a manual assembly process. The gripping arms 350, 352 may also allow each filter 306 to be securely held in a desired position on the substrate 310 until the filter 306 becomes coupled to the substrate 310. The coupling may be achieved by conventional techniques, such as by using adhesive (e.g., epoxy), or by more advanced processing steps, such as fusing the filters 306 to the substrate 310, due to the stability provided by the gripping arms 350, 352.

In the embodiment shown in FIGS. 5A and 5B, the portions of the gripping arms 350, 352 adjacent the opposed sides 324, 326 of the filter 306 have a thickness that is less than a thickness of the filter 306 (the latter defined by the distance between the optical surface 320 and the back surface 322). Thus, these portions of the gripping arms 350, 352 are between the first and second planes P₁, P₂, within the open regions over the substrate 310 that are faced by the opposed sides 324, 326 of the filter 306. This allows neighboring filters 306 to be positioned on or close to side planes defined by the opposed sides 324, 326 of a given filter 306. Referring back to FIG. 4, such side planes are illustrate as side planes S₁, S₂ for a representative filter 306, and distances from the side planes S₁, S₂ to neighboring filters are labeled as d_{S1} and d_{S2}. The distances d_{S1} and d_{S2} may be relatively small (e.g., less than the width of a given filter 306, less than half the width of a given filter 306, less than a quarter of the width of a given filter 306, etc.) or even zero in some embodiments, thereby maintaining a lower overall footprint for the arrangement of filters 306.

Referring back to FIG. 3, the filters 306 within the first and second filter sets 316(1), 316(2) are staggered in a linear manner. The linear staggering results in the opposed sides 324, 326 of each filter 306 facing a respective region over the substrate 310 that is free from not only a neighboring filter 306 (if there is one), but also any other filter 306. Also, as shown, the channel ports 304 may have a staggered arrangement to match that of the filters 306 so that the regions faced by the opposed sides 324, 326 of a given filter 306 are not obstructed by (i.e., remain free of) the channel port 304 associated with a neighboring filter 306. The common port 302 may also be arranged so as to not obstruct the region faced by the side 324 of the nearest filter 306(2) in the second filter set 316(2). Thus, the channel ports 304 and the common port 302 do not interfere with using the gripping arms 350, 352 (FIGS. 5A and 5B) to position the filters 306 on the substrate 310. The gripping arms 350, 352 may also be used to position the common port 302 and the channel ports 304 on the substrate 310.

As mentioned above, the staggered arrangement of the filters 306 may be particularly beneficial for DWDM applications. The close proximity in wavelength of the signal channels in such applications drives a need for smaller angles of incidence (AOIs) in the optical path 312. In some embodiments, the AOI α associated with each filter 306 is four degrees or less, three degrees or less, or even two degrees or less. This, in turn, drives closer lateral spacing between neighboring filters 306 (i.e., a small distance d_{S1} and/or d_{S2}; see FIG. 4). Despite such close lateral spacing, the gripping arms 350, 352 (FIGS. 5A and 5B) may be still be used to perform automated assembly of the filters 306 onto the substrate 310 due to the staggered arrangement of the filters 306, as described above.

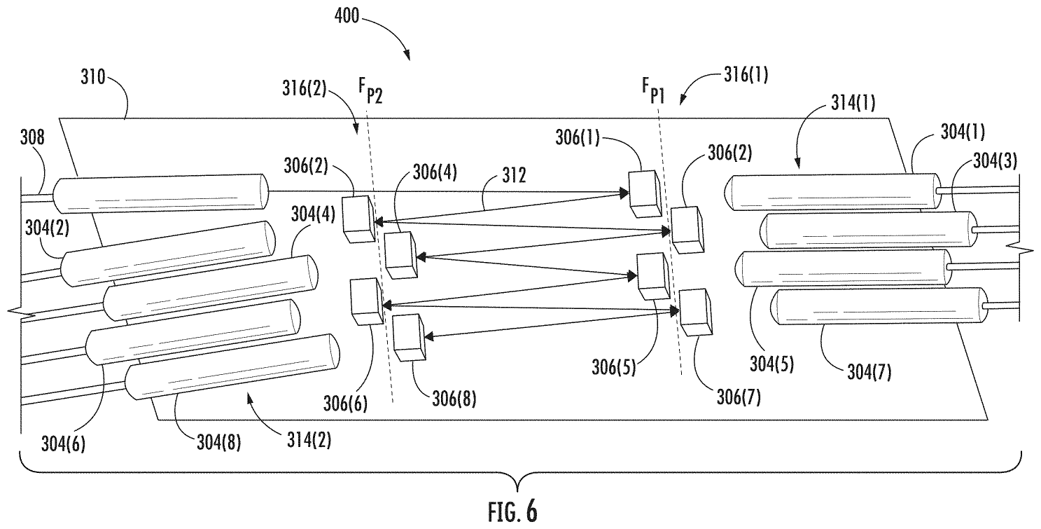

FIG. 6 illustrates another example of a WDM device 400 according to this disclosure involving a different staggered arrangement of components. In particular, the WDM device 400 includes the same components as the WDM device 300 (FIG. 3) such that similar reference numbers are used in FIG. 6 for the components (e.g., the common port 302, channel ports 304, and filters 306). Only the different arrangement of the components in the WDM device 400 need be described since reference can be made to the description above for a more complete understanding of the components themselves.

In the WDM device 400, the filters 306 within the first and second filter sets 316(1), 316(2) are staggered in an alternating manner. For example, the filters 306 in the first filter set 316(1) are arranged so that neighboring filters 306 are on opposite sides of a plane F_{P1}. Thus, the first filter 306(1) is arranged on a first side of the plane F_{P1}. (to the left in FIG. 6), the third filter 306(3) is arranged on a second side of the plane F_{P1}. (to the right in FIG. 6), the fifth filter 306(5) is arranged on the first side of the plane F_{P1}, and the seventh filter 306(7) is arranged on the second side of the plane F_{P1}. Similarly, the filters 306 in the second filter set 316(2) are arranged so that neighboring filters are on opposite sides of a plane F_{P2}. Thus, the second filter 306(2) is arranged on a first side of the plane F_{P2} (to the left in FIG. 6), the fourth filter 306(4) is arranged on a second side of the plane F_{P2} (to the right in FIG. 6), the sixth filter 306(6) is arranged on the first side of the plane F_{P2}, and the eighth filter 306(8) is arranged on the second side of the plane F_{P2}.

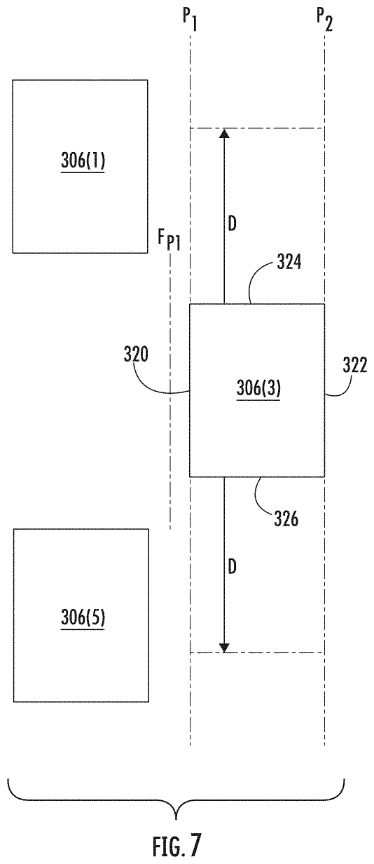

FIG. 7 is similar to FIG. 4, but schematically illustrates the filters 306(1), 306(3), and 306(5) from the WDM device 400 instead of the WDM device 300 (FIGS. 3 and 4). Like FIG. 4, geometric annotations are added to one of the filters 306 (filter 306(3)), and the principles discussed with respect to that filter 306(3) may apply to any of the other filters 306 in the WDM device 400 (including those not illustrated in FIG. 7).

As shown in FIG. 7, the region over the substrate 310 that is faced by one of the sides 324, 326 of the filter 306(3) is still bound by the first and second planes P1, P2. Neither the first plane P1 nor the second plane P2 intersect a neighboring filters 306 (filter 306(1) or filter 306(5)) due to the staggered arrangement of the filters 306. FIG. 7 also illustrates a distance D away from a given side 324, 236, with the distance D being measured perpendicular to the side 324, 326 and within the associated region. The associated region remains unoccupied by any other filter 306 for at least the distance D, which in the illustrated embodiment is equal to a width of the filter 306(3). Such an arrangement provides sufficient open space for assembly equipment to grip the opposed sides 324, 326 of the filter 306(3) (e.g., in the same manner discussed above with respect to FIGS. 5A and 5B for the WDM device 300).

As can be appreciated from both FIGS. 6 and 7, the alternating staggering of components still results in the opposed sides 324, 326 of each filter 306 facing a respective region over the substrate 310 that is free from a neighboring filter 306 (if there is one). Also, as shown, the channel ports 304 may have a staggered arrangement to match that of the filters 306 so that the regions faced by the opposed sides 324, 326 of a given filter 306 are not obstructed by (i.e., remain free of) the channel port 304 associated with a neighboring filter 306. The common port 302 may also be arranged so as to not obstruct the region faced by the side 324 of the filter 306(2) in the second filter set 316(2) that is nearest the common port 302. Thus, the channel ports 304 and the common port 302 do not interfere with using the gripping arms 350, 352 (FIGS. 5A and 5B) to position the filters 306 on the substrate 310.

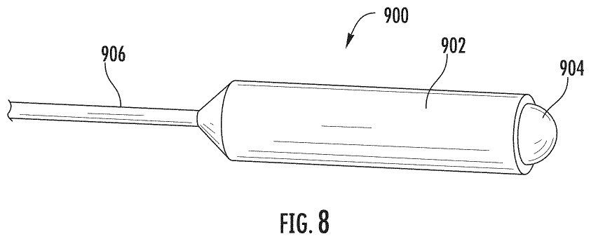

FIGS. 8-11B illustrate example collimators that may be used as ports (e.g., the common port 302 and the channel ports 304) in WDM devices according to this disclosure. For example, FIG. 8 illustrates an example tube collimator 900 that includes a tube body 902 with a curved lens 904 at one end of the tube body 902. A fiber pigtail 906 is located at an opposite end of the tube body 902. The fiber pigtail 906 comprises an optical fiber 908 that is supported within tube body 902 and optically aligned with the curved lens 904. The optical fiber 908 extends from the tube body 902.

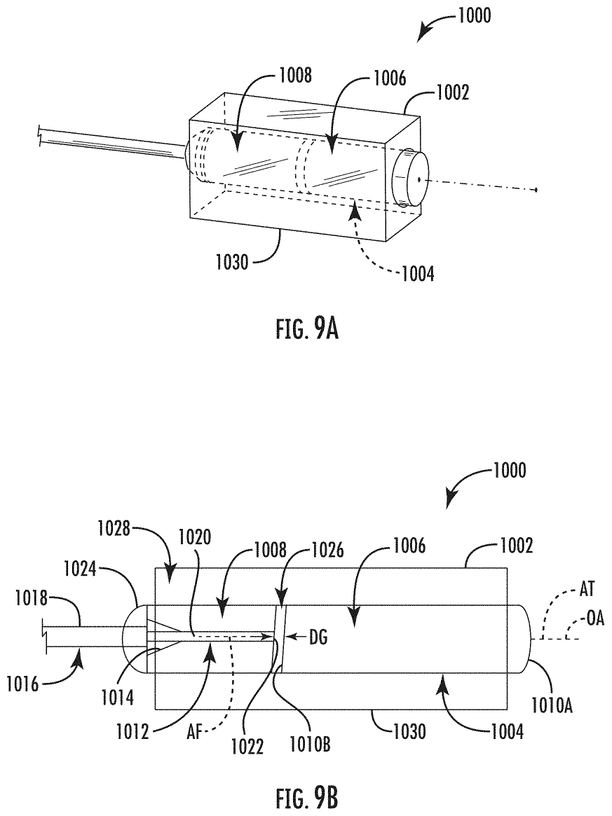

FIGS. 9A and 9B illustrate another example collimator 1000 includes a cylindrical, glass tube 1002 with a central bore 1004. The term “cylindrical” is used in this disclosure in its most general sense and may be defined as a three-dimensional object formed by taking a two-dimensional (2D) shape and projecting it in a direction perpendicular to the associated 2D plane. Thus, a cylinder, as the term is used in this disclosure, is not limited to having a circular cross-section shape but may have any cross-sectional shape, such as the square cross-sectional shape shown in FIGS. 9A and 9B.

The collimator 1000 further includes optical elements, such as a collimating lens 1006, a ferrule 1008, etc., that may be secured to the glass tube 1002 using adhesive or other means. The collimating lens 1006 has a front surface 1010A and a back surface 101013 opposite the front surface 1010A. In the example shown, the front surface 1010A is convex while the back surface 1010B is angled, e.g., in a plane perpendicular to an optical axis OA. In an example, the front surface 1010A of collimating lens 1006 may reside outside of the central bore 1004, i.e., the front-end portion of the collimating lens 1006 may extend slightly past the front end of the glass tube 1002. In an alternative embodiment not shown, the collimating lens 1006 may be formed as a gradient-index (GRIN) element that has a planar front surface 1010A. The collimating lens 1006 may consist of a single lens element or of multiple lens elements. In the discussion below, the collimating lens 1006 is shown as a single lens element for ease of illustration and discussion.

The ferrule 1008 includes a central bore 1012 that runs between a front end and a back end along a ferrule central axis AF, which may be co-axial with a tube central axis AT of the glass tube 1002 and the optical axis OA defined by the collimating lens 1006. The central bore 1012 may include a flared portion 1014 at the back end of the ferrule 1008.

An optical fiber 1016 has a coated portion 1018 and an end portion 1020, the latter being bare glass (e.g., is stripped of coating) and is thus referred to as the “bare glass portion 1020.” The bare glass portion 1020 includes a polished end face 1022 that defines a proximal end of the optical fiber 1016. The bare glass portion 1020 extends into the central bore 1012 of the ferrule 1008 at the back end of the ferrule 1008. Adhesive 1024 may be disposed around the optical fiber 1016 at the back end of the ferrule 1008 and/or within the central bore 1012 to secure the optical fiber 1016 to the ferrule 1008. The front end of the ferrule 1008 is angled in a plane perpendicular to the ferrule central axis AF and is axially spaced apart from the angled back end of the collimating lens 1006 to define a gap 1026 that has a corresponding axial gap distance DG. While the optical fiber 1016 is described above as being glass, other types of optical fibers may be used, such as, for example, a plastic optical fiber.

The ferrule 1008 and optical fiber 1016 constitute a fiber pigtail 1028, which can be said to reside at least partially within the central bore 1004 adjacent the back end of the glass tube 1002. Thus, in an example, the collimator 1000 includes only the glass tube 1002, the collimating lens 1006, and the fiber pigtail 1028. The glass tube 1002 serves in one capacity as a small lens barrel that supports and protects the collimating lens 1006 and the fiber pigtail 1028, particularly the bare glass portion 1020 and its polished end face 1022. The glass tube 1002 also serves in another capacity as a mounting member that allows for the collimator 1000 to be mounted to a support substrate (e.g., the substrate 310; FIGS. 3 and 6). In this capacity, at least one flat surface 1030 serves as a precision mounting surface.

The glass tube 1002, the collimating lens 1006, and the ferrule 1008 may all made of a glass material, and some embodiments, are all made of the same glass material. Making the glass tube 1002, the collimating lens 1006, and the ferrule 1008 out of a glass material has the benefit that these components will have very close if not identical coefficients of thermal expansion (CTE). This feature is particularly advantageous in environments that can experience large swings in temperature.

The optical elements used in the collimator 1000 are sized to be slightly smaller than the diameter of the central bore 1004 (e.g., by a few microns or tens of microns) so that the optical elements may be inserted into the central bore 1004 and moved a select location. The optical elements and the support/positioning elements may be inserted into and moved within the central bore 1004 to their select locations using micro-positioning devices. The optical elements and the support/positioning elements may be secured within the central bore 1004 using a number of securing techniques, such as securing with an adhesive (e.g., a curable epoxy), glass soldering, glass welding, or some combination of these techniques.

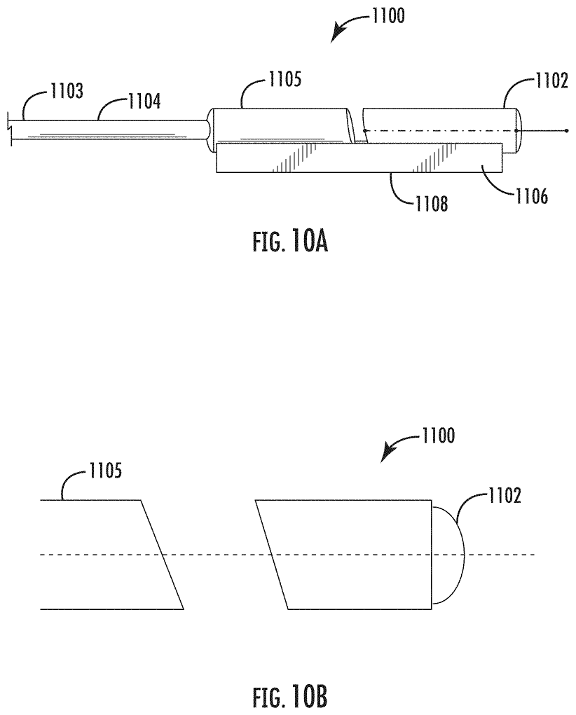

FIG. 10A is a perspective view of another example of a collimator 1100 for use with the components and devices of FIGS. 3-7. The collimator 1100 includes a lens 1102 (e.g., a glass or silica collimating lens), a fiber pigtail 1104 (e.g., an optical fiber 1103 terminated by a ferrule 1105), and a base 1106 that defines a groove (e.g., a generally v-shaped groove). The lens 1102 and the fiber pigtail 1104 are disposed in the groove and supported by the base 1106. The lens 1102 is configured to receive a light signal provided to a WDM device (e.g., the WDM devices 300, 400) from an external optical transmission system (not shown) or to pass a light signal from the WDM device to the external optical transmission system. The fiber pigtail 1104 is optically coupled to the lens 1102 and is configured to provide the light signal to the lens 1102 from the external optical transmission system and/or to receive the light signal from the lens 1102 for transmission to the external optical transmission system.

As schematically illustrated in FIG. 10B, there may be a gap/space between the lens 1102 and the ferrule 1105 of the fiber pigtail 1104. The lens 1102 and the ferrule 1105 may be secured to the base 1106 (FIG. 10A) independent of each other to allow for precise adjustment of the gap size to achieve desirable optical properties (e.g., low attenuation of the optical signal passing through the collimator 1100). The base 1106 of the collimator 1100 has a generally flat bottom surface 1108 for mounting on a substrate (e.g., the substrate 310). In some embodiments, the base 1106 has a width that is less than a width of the lens 1102 and a width of the ferrule 1105.

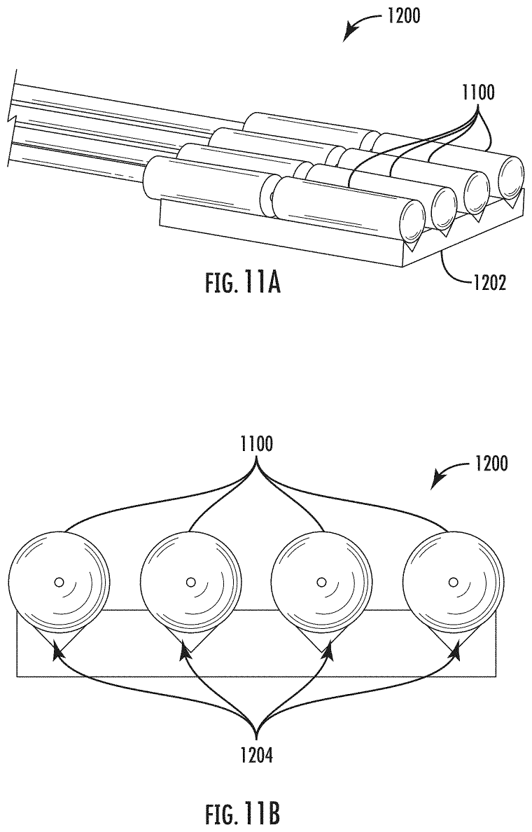

FIGS. 11A and 11B are views of an example array 1200 of the collimators 1100 of FIGS. 10A and 10B. The collimators 1100 are arranged side-by-side on a surface of a base 1202 that includes a plurality of grooves (similar to the base 1106; see FIG. 10A). Although FIG. 11A illustrates front ends of the collimators 1100 being generally aligned in a common plane, it will be appreciated that the collimators 1100 may be arranged in a staggered manner (i.e., with the front ends of neighboring collimators 1100 being offset from each other in an axial direction) when used in WDM devices according to this disclosure.

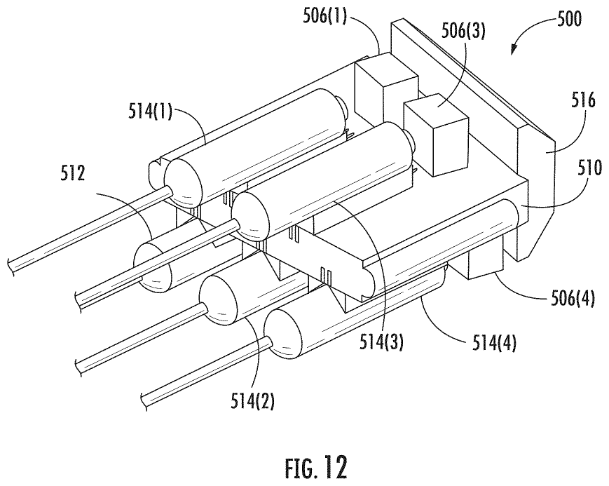

Those skilled in optical connectivity will appreciate that modifications and variations to the embodiments described above can be made without departing from the spirit or scope of the present disclosure. For example, although the WDM devices 300, 400 include the filters 306 arranged on a common side (e.g., a top side) of the substrate 310, the same principles may be applied to WDM devices having filters coupled to different sides of a substrate. FIG. 12, for example, illustrates an example of a WDM device 500 having filters 506(1)-506(4) coupled to opposite sides (e.g., a top side and a bottom side) of a substrate 510. Specifically, filters 506(1), 506(3) are coupled to a top side of the substrate 510, and filters 506(2) (hidden in FIG. 12), 506(4) are coupled to a bottom side of the substrate 510. The WDM device 500 also includes a common port 512 and two channel ports 514(2), 514(4) coupled to a bottom side of the substrate 510, two channel ports 514(1), 514(3) coupled to the top side of the substrate 510, and an optical signal router 516 in the form of a trapezoidal-shaped prism for routing an optical signal between the top and bottom sides of the substrate 510. This type of WDM device is known and described, for example, in the background section of U.S. Pat. No. 10,313,045 (“the '045 patent”), the disclosure of which is fully incorporated herein by reference. Skilled persons will appreciate that the principles of the present disclosure may be applied to such a WDM device or other WDM devices having optical components arranged on opposing sides of a substrate (see, e.g., various additional embodiments disclosed in the '045 patent). For example, the filters 506A, 506C may have a staggered arrangement on the top side of the substrate 510 and/or the filters 506B, 506D may have a staggered arrangement on the bottom side of the substrate 510. The common port 512 and the channel ports 514A-514D may also be staggered relative to each other as discussed above for the WDM devices 300, 400.

The are many other alternatives and variations that will be appreciated by persons skilled in optical connectivity. For at least this reason, the invention should be construed to include everything within the scope of the appended claims and their equivalents.

What is claimed is:

1. A wavelength division multiplexing (WDM) device, comprising:
a substrate;
a common port coupled to the substrate and configured for communication of a combined optical signal that includes different signal channels; and
a plurality of filters coupled to the substrate, wherein the common port and the plurality of filters define an optical path for the combined optical signal, with each filter of the plurality of filters being configured to pass one of the signal channels and to reflect any remainder of the signal channels;
wherein:
each filter of the plurality of filters comprises an optical surface in the optical path, a back surface opposite the optical surface, and opposed sides extending between the optical surface and the back surface, and
the plurality of filters have a staggered arrangement so that the opposed sides of each filter face an associated region over the substrate that is not occupied by a neighboring filter in the plurality of filters.

2. A WDM device according to claim 1, wherein the staggered arrangement comprises a linear staggering of the plurality of filters so that the opposed sides of each filter face an associated region over the substrate that is not occupied by any other filter in the plurality of filters.

3. A WDM device according to claim 1, wherein the staggered arrangement comprises an alternating stagger of the plurality of filters such that the sides of at least two, non-neighboring filters of the plurality of filters face each other.

4. A WDM device according to claim 1, wherein the optical path intersects each filter of the plurality of filters at an angle of incidence that is less than 4 degrees.

5. A WDM device according to claim 1, wherein the plurality of filters comprises a first filter set and a second filter set configures so that the optical signal path alternates between a filter of the first filter set and a filter of the second filter set until the optical signal path reaches a final filter in the plurality of filters.

6. A WDM device according to claim 5, wherein each of the first filter set and the second filter set comprises at least two filters of the plurality of filters.

7. A WDM device according to claim 5, wherein each of the first filter set and the second filter set comprises at least four filters of the plurality of filters

8. A WDM device according to claim 1, wherein the first filter set and the second filter set are arranged on opposite top and bottom sides of the substrate, the WDM device further comprising:
an optical signal router coupled to the substrate and positioned within the optical signal path, the optical signal router being configured to direct the optical signal path between the top and bottom sides of the substrate.

9. A WDM device according to claim 1, further comprising:
a plurality of channel ports coupled to the substrate, wherein each channel port of the plurality of channel ports is optically aligned with a respective filter of the plurality of filters and thereby configured for optical communication of the signal channel associated with the respective filter.

10. A WDM device according to claim 9, wherein the plurality of channel ports have a staggered arrangement that matches the staggered arrangement of the plurality of filters, such that the regions over the substrate that are faced by the opposed sides of each filter in the plurality of filters are not occupied by the channel port that is optically aligned with the neighboring filter in the plurality of filters.

11. A WDM device according to claim 1, wherein the common port is arranged on the substrate so as to not occupy the region over the substrate that is faced by one of the opposed sides of the nearest filter in the plurality of filters.

12. A method of assembling a wavelength division multiplexing (WDM) device, comprising:
arranging a common port on a substrate, wherein the common port is configured for communication of a combined optical signal that includes different signal channels; and
arranging a plurality of filters on the substrate, wherein the common port and the plurality of filters define an optical path for the combined optical signal, with each filter of the plurality of filters being configured to pass one of the signal channels and to reflect any remainder of the signal channels;
wherein:
each filter of the plurality of filters comprises an optical surface in the optical path, a back surface opposite the optical surface, and opposed sides extending between the optical surface and the back surface, and
the plurality of filters are arranged on the substrate to have a staggered arrangement so that the opposed sides of each filter face an associated region over the substrate that is not occupied by a neighboring filter in the plurality of filters.

13. A method according to claim 12, wherein arranging the plurality of filters on the substrate further comprises:
moving each filter of the plurality of filters into a desired position on the substrate with robotic gripping arms, wherein the robotic gripping arms hold the opposed sides of the filter during such moving.

14. A method according to claim 13, further comprising:
for each filter of the plurality of filters, holding the filter with the robotic gripping arms in the desired position until the filter is secured relative to the substrate.

15. A method according to claim 12, wherein the staggered arrangement comprises a linear staggering of the plurality of filters so that the opposed sides of each filter face an associated region over the substrate that is not occupied by any other filter in the plurality of filters.

16. A method according to claim 12, wherein the staggered arrangement comprises an alternating stagger of the plurality of filters such that the sides of at least two, non-neighboring filters of the plurality of filters face each other.

17. A method according to claim 12, wherein the optical path intersects each filter of the plurality of filters at an angle of incidence that is less than 4 degrees.
